(19) United States
(12) Patent Application Publication
(10) Pub. No.: US 2016/0149826 A1
(43) Pub. Date: May 26, 2016

(54) MEMORY USAGE OPTIMIZATION METHOD

(71) Applicant: NOKIA TECHNOLOGIES OY, Espoo (FI)

(72) Inventor: Yongbeom PAK, Oulu (FI)

(21) Appl. No.: 14/893,236

(22) PCT Filed: May 24, 2013
(86) PCT No.: PCT/FI2013/050567

§ 371 Date: Nov. 23, 2015

(51) Int. Cl. H04L 12/911; H04L 29/08; H04L 29/06

(52) U.S. Cl. CPC H04L 47/70; H04L 67/42; H04L 67/26

(57) ABSTRACT

The invention relates to memory usage optimization. A method for memory usage optimization comprises establishing a connection between a client device and a server suitable to have a plurality of connections with a plurality of client devices, utilizing a server memory of the server for establishing and maintaining connection of the client device with the server by connection content data and data structures, storing the connection content data and data structures to a disk from the server memory when the connection shifts to an idle state, and removing the connection data and data structure from the server memory.

### BACKGROUND

Today a mobile user expects immediate access to fresh, relevant data in the internet. Fresh data can be brought to users, for example, by real-time push notifications. Before an application can receive notifications, the user has to subscribe to information channels provided by a server (i.e. a connection is established between the user's device [i.e. a client] and the server); whenever new content is available on one of those channels, the server pushes that information out to the client. Real-time push notifications are a battery saving technology that allows instant updates without polling. Such a service may utilize data compression algorithm to reduce size of message that need to be delivered to user device.

However, the increasing use of internet services demands a high number of concurrent connections from the server. The high number of concurrent connections requires high resource usage in the server. Server memory is utilized for establishing and maintaining connection of a user with the server. Generally the server does not terminate a connection after response data has been served to a user. The server leaves the connection open so that if an event is received by the server or service, it can be sent immediately to one or multiple users; otherwise, the data would have to be queued until the client's next request is received. This high memory utilization limits the number of active users served by a single server. Each user connection may require 300 kB or more memory. The memory is required for user authentication, for example, through ZLIB compression algorithm (i.e. 300 KB memory) and for real-time push notification service, for example through ZLIB and/or Transport Layer Security (TLS) stream compression.

### SUMMARY

The present application relates generally to memory usage optimization of a server, for example, a real-time push notification server, a video or audio streaming server or any other suitable server that uses persistent connections. Now there has been invented an improved method and technical equipment implementing the method. Various aspects of the invention include a method, an apparatus, and a computer readable medium comprising a computer program stored therein, which are characterized by what is stated in the independent claims. Various embodiments of the invention are disclosed in the dependent claims.

According to a first aspect of the invention, there is provided a method, comprising establishing a connection between a client device and a server suitable to have a plurality of connections with a plurality of client devices, utilizing a server memory of the server for establishing and maintaining connection of the client device with the server by connection content data and data structures, storing the connection content data and data structures to a disk from the server memory when the connection shifts to an idle state, and removing the connection data and data structure from the server memory.

According to an embodiment, the server is a real-time push notification server. According to an embodiment, the method further comprises restoring the connection data and data structure to the server memory when server is indicated about a real-time push notification to be delivered to the client device. According to an embodiment, the server is a video or audio streaming server. According to an embodiment, the connection content data and data structures are stored to the disk after the connection has been in the idle state for a predetermined time. According to an embodiment, the connection content data and data structures are stored to the disk in the idle state if the server has more than a predetermined number of concurrent connections with client devices. According to an embodiment, the connection content data and data structures are stored to the disk in every second or third idle state. According to an embodiment, the connection content data and data structures are stored to the disk for idle state if the server memory capacity is running low.

According to a second aspect of the invention, there is provided an apparatus comprising at least one processor, memory including computer program code, the memory and the computer program code configured to, with the at least one processor, cause the apparatus to perform at least the following: establish a connection between a client device and a server suitable to have a plurality of connections with a plurality of client devices, utilize a server memory of the server for establishing and maintaining connection of the client device with the server by connection content data and data structures, store the connection content data and data structures to a disk from the server memory when the connection shifts to an idle state, and remove the connection data and data structure from the server memory.

According to an embodiment, the server is a real-time push notification server. According to an embodiment, the computer program code configured to, when executed on at least one processor, further cause the apparatus to restore the connection data and data structure to the server memory when server is indicated about a real-time push notification to be delivered to the client device. According to an embodiment, the server is a video or audio streaming server. According to an embodiment, the connection content data and data structures are stored to the disk after the connection has been in the idle state for a predetermined time. According to an embodiment, the connection content data and data structures are stored to the disk in the idle state if the server has more than a predetermined number of concurrent connections with client devices. According to an embodiment, the connection content data and data structures are stored to the disk in every second or third idle state. According to an embodiment, the connection content data and data structures are stored to the disk for idle state if the server memory capacity is running low.

According to a third aspect of the invention, there is provided a computer program product embodied on a non-transitory computer readable medium, comprising computer program code configured to, when executed on at least one processor, cause an apparatus to establish a connection between a client device and a suitable to have a plurality of connections with a plurality of client devices, utilize a server memory of the server for establishing and maintaining connection of the client device with the server by connection content data and data structures, store the connection content data and data structures to a disk from the server memory when the connection shifts to an idle state, and remove the connection data and data structure from the server memory.

According to an embodiment, the server is a real-time push notification server. According to an embodiment, the computer program code configured to, when executed on at least one processor, further cause the apparatus to restore the connection data and data structure to the server memory when server is indicated about a real-time push notification to be delivered to the client device.

According to a fourth aspect of the invention, there is provided an apparatus, comprising means for establishing a connection between a client device and a server suitable to have a plurality of connections with a plurality of client devices, means for utilizing a server memory of the server for establishing and maintaining connection of the client device with the server by connection content data and data structures, means for storing the connection content data and data structures to a disk from the server memory when the connection shifts to an idle state and means for removing the connection data and data structure from the server memory.

According to an embodiment, the server is a real-time push notification server. According to an embodiment, the apparatus further comprises means for restoring the connection data and data structure to the server memory when server is indicated about a real-time push notification to be delivered to the client device. According to an embodiment, the server is a video or audio streaming server. According to an embodiment, the connection content data and data structures are stored to the disk after the connection has been in the idle state for a predetermined time. According to an embodiment, the connection content data and data structures are stored to the disk in the idle state if the server has more than a predetermined number of concurrent connections with client devices. According to an embodiment, the connection content data and data structures are stored to the disk in every second or third idle state. According to an embodiment, the connection content data and data structures are stored to the disk for idle state if the server memory capacity is running low.

### DESCRIPTION OF THE DRAWINGS

In the following, various embodiments of the invention will be described in more detail with reference to the appended drawings, in which

FIG. 1 shows a real-time push notification system with a server memory optimizing according to an example embodiment;

FIG. 2 shows a chart of a real-time push notification system with a server memory optimizing according to an example embodiment; and

FIG. 3 shows a flow chart of a server memory optimizing method for a real-time push notification system according to an example embodiment.

### DESCRIPTION OF EXAMPLE EMBODIMENTS

Real-time push notifications relating to information preferences expressed in advance for a push notification server are a convenient way of keeping mobile users in touch with fresh and relevant information, for example, in the internet. Server memory is utilized for establishing and maintaining connection of the client with the push notification server for real-time push notifications. The server memory is required for user authentication, for example, through ZLIB compression algorithm and for real-time push notification service, for example through ZLIB and/or Transport Layer Security (TLS) stream compression. Each connection between the client and the push notification server may require 300 KB or more server memory.

This high server memory utilization may limit the number of active users served by a single push notification server. In order to enable real-time push notifications to be delivered to everyone who wants to receive them—regardless of which mobile, desktop or media device they happen to be using—the push notification server memory utilization should be optimized so that the memory utilization does not so intensely limit the number of active users served by a single push notification server.

Each time when the connection between a client and a push notification server switches to an idle state i.e. to a state, where no notification is needed to be delivered to the client, the push notification server moves connection information comprising data and data structures, for example, internal data structure required for ZLIB compression or other compression method, state of user/client session, user/client specific information or any other information that is needed to provide service to the user/client, to a disk e.g. a non-volatile, persistent memory and destroys them from the server memory location e.g. RAM, thereby freeing the server memory for other active connections to overcome the memory limit of the push notification server. For any real-time push notification delivery from the server to the client in future, the server restores the client's connection information i.e. the data and data structures from the disk back to the server memory.

Thus, by moving the connection information to the disk for the idle state worth, a single push notification server can serve an increasing number of active client connections on the push notification server. This server memory capacity discharging for the idle state may be called a server memory optimizing method.

In the following, several embodiments of the invention will be described in the context of an apparatus, for example, a push notification server. The server is suitable to transmit real-time push notifications to a client i.e. a client device comprising an internet-access i.e. means for connecting the device to the computer networks, such as the world wide web (WWW) by mobile, wired or wireless connection, for example, WAN or WLAN. The push notification server is a system, hardware and software, that may respond to requests across a computer network to provide, or help to provide, a network service. Servers can be run on a dedicated computer, which may be referred to by a term “the server”, but many networked computers are capable of hosting servers. In many cases a computer can provide several services and have several servers running. Servers may operate within a client-server architecture; servers are computer programs running to serve the requests of other programs, the clients. Thus, the server performs some task on behalf of clients. The clients either run on the same computer, or they connect through the computer network. The device i.e. a mobile client may be, for example, a, mobile phone, a mobile computer, a mobile collaboration device, a mobile internet device, a smart phone, a tablet computer, a tablet personal computer (PC), a personal digital assistant, a handheld game console, a portable media player, a digital video camera (DVC or digital camcorder), a pager, or a personal navigation device (PND).

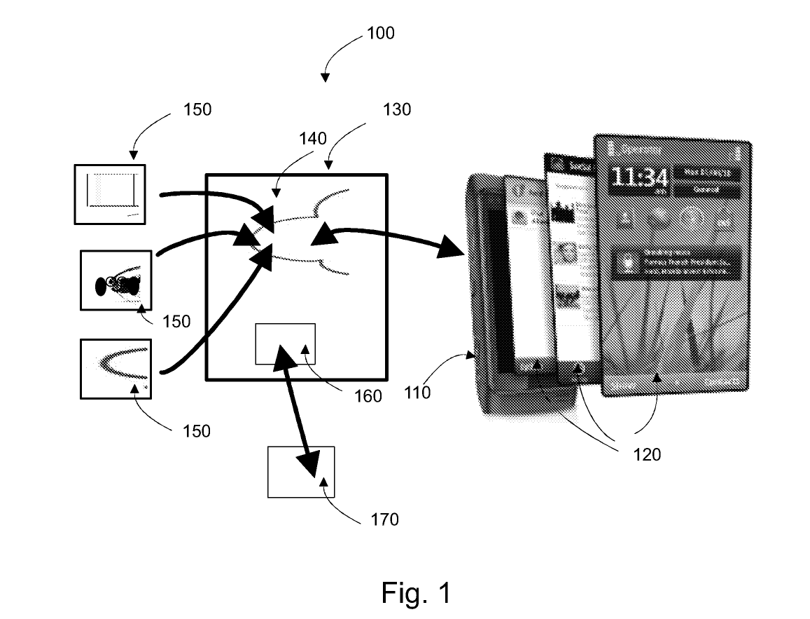

FIG. 1 shows a real-time push notification system 100 with a server memory optimizing method according to an example embodiment. The system comprises a device i.e. a client device 110, an apparatus i.e. a push notification server 130 comprising a real-time push notification service 140 and a service's application server 150. A Client API (Application Programming Interfaces) which is arranged to handle the connection between user device and the server resides on the client device 110 and allows applications 120 on the client device 110 to receive notifications. For receiving push notifications, for example, real-time push notifications, the client should log in to the notification service 140, for example, by using notification ID. The notification ID uniquely identifies both the end user (client device 110) and the target application 120 and is used by the notification service 140 to properly route notifications. The logging in to the notification service 140 may be done by connecting the client device 110 with the server 130, for example, through ZLIB compression. User authentication through ZLIB compression may require, for example, 300 kB server memory 160. The server memory 160 may be, for example, RAM type memory. So, the server memory 160 is utilized for establishing (authentication and logging in) the connection between the client device 110 with server 130, but also for maintaining the connection of the client device 110 with server 130. And when the client device 110 is connected to the notification service 140 of the server 130, it is ready to receive available real-time push notifications from the notification service 140. The real-time push notification to the authenticated and connected client device 110, for example, through ZLIB and/or TLS stream compression requires the above mentioned connection information, but also capacity of the server memory 160. Thus, the notification service 140 stores all the information needed to maintain the connection and to real-time push notification into the server memory 160 in connection with forming the connection. However, because the required server memory capacity of each connection may be quite high, for example, 300 kB or more, and the notification service 140 of the server 130 serves many clients, the server 130 may transfer the connection information (data and data structures) to a separate disk 170 e.g. a non-volatile, persistent memory from the server memory 160, when the connection is in an idle state. The idle state is a state, where no notification is needed to be delivered to the client device 110 by the notification service 140. When the connection information is stored in the disk 170, the server 130 destroys the connection information from the server memory 160, thereby freeing the server memory 160 for other active connections. The disk 170 may be an internal memory of the server 130 or it may be an external memory. However, it is also possible that in the idle state the server 130 stores data to the disk 170 and removes data from the server memory 160, but keeps the data structures in the server memory.

A service's application server 150 generates notifications. Generated notifications are sent to the notification service 140. When the notification service 140 receives at least one notification that is specified by the notification ID, the server 130 restores the connection information (data and data structures) relating to that notification ID from the disk 170 to the memory 160. Then the notification service 140 delivers received notifications to the client device 110 relating to that notification ID over the connection established between the client 110 and the notification service 140. Once a notification is received on the client device 110, it will be delivered to the appropriate application 120 through the Notification Client API. Delivery can occur regardless of the current state of the target application 120, whether it is active, in the background, or even if it is not running, in which case it can be woken up and launched. Then the client device 110 may alert the user of the client device 110 by some means available on the device, i.e. sound, pop-up window, by opening the application etc. Application 120 receiving notifications may be, for example, a navigation application that alerts mobile device users to changes in optimal routes and even updates the weather conditions for their destinations or a music store that suggests music play lists based on the user's social network favorites or a news application that sends the latest headlines as soon as they are available.

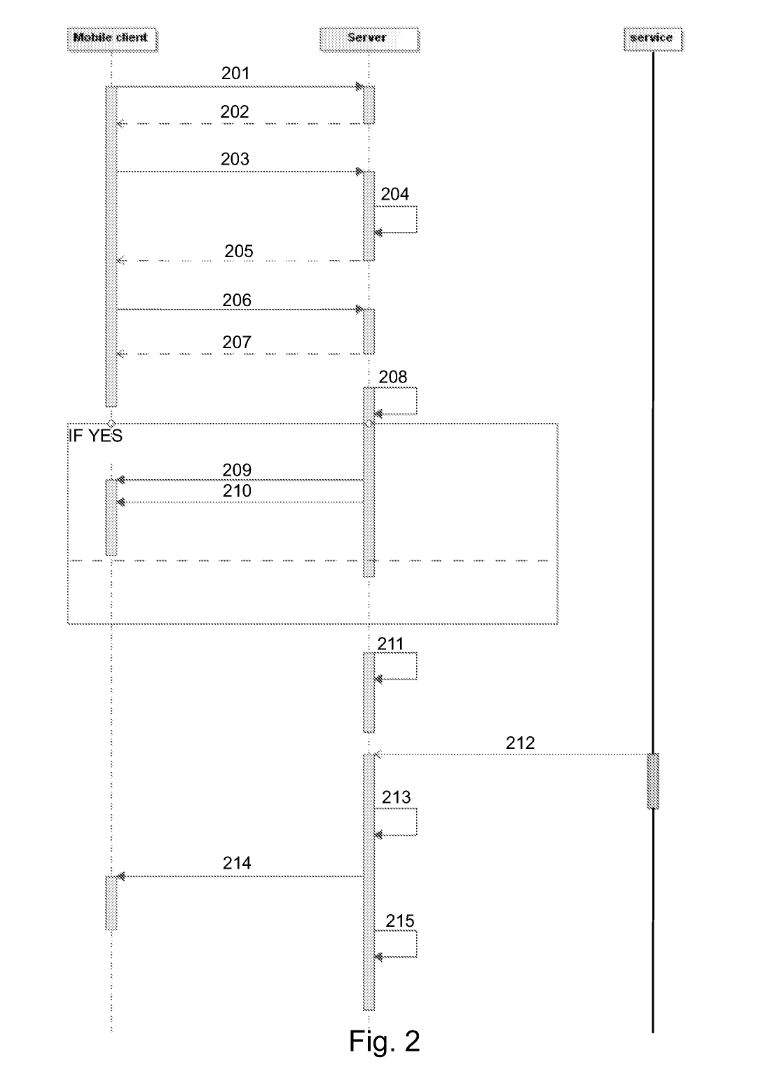

FIG. 2 shows a chart of a real-time push notification system with a server memory optimizing according to an example embodiment. At the beginning, a user is authenticated normally with ZLIB compression (steps 201-207). In step 201, a mobile client starts to connect to a server. In step 202, the server indicates that ZLIB compression is available. In step 203, the mobile client indicates that it is going to use the compression method. The mobile client may initiate compression method in this step 203. In step 204, the server initiates ZLIB. In step 205, the server indicates that the ZLIB compression is initiated and ready to compress. In step 206, the mobile client initiates the compression method if it is not already done in step 203. All data that is transferred between the mobile client and the server in step 206 and/or further coming steps is compressed by compression method. In addition, in step 206, the mobile client logs in to the server by delivering its identification to the server. Identification includes at least a notification ID and may also include any forms of data that is needed to validate the user session i.e. the connection between the mobile client and the server. In step 207, the server validates the client identification and indicates that the login has succeeded. This validation process may consist one step or more than one steps, for example, a digest access authentication requires a challenge response schema that includes more than one steps. In step 208, the server checks if there is any stored notification to be delivered to the mobile client. If yes i.e. there is at least one notification for the client, the server sends those existing notifications to the client, steps 209 and 210 (step 210 is optional). After sending at least one notification to the client or if there were any notifications to be sent (i.e. the server is in an idle state) the server stores connection data and possible data structures i.e. the ZLIB compression dictionary and state to a disk from the server memory and removes that stored data from the server memory, in step 211. In step 212, the server receives from a service a notification to be delivered to the client. In step 213, the server restores needed information for the notification delivery from the disk to the server memory. If data structure has been destroyed (in step 211), the server creates a new data structure and restore the data from the disk to the server memory. In step 214, the server sends at least one existing notification to the client. After sending at least one notification to the client, the server shifts to the idle state again. And again in the idle state, step 215, the server stores connection data and possible data structures to the disk from the server memory and removes that data from the server memory. However, it is also possible, for example, if the server has enough memory capacity that the server does not store the connection data and data structures to disk immediately after moving to the idle state.

Before storing the connection data and data structures to disk, the server may, for example, wait for a predetermined time or the server may move the data to the disk only in every other or third idle state or when it notices that the server memory capacity is running low or if a number of client connections exceeds a predetermined number of concurrent client connections, or if an estimated next notification time is higher than the predetermined time. The estimated notification time may be estimated by machine learning giving an estimated value for the idle time by analyzing the timestamp of notification delivered from different services subscribed by the mobile client (user) and/or on the basis of other features such as user amount, system load, system usage pattern etc. In addition it is possible that the server does not move/store the connection data and data structures to the disk at all or that it mixes above mentioned methods.

It is also possible that a push notification server restores from a disk only a part of the data relating to a notification ID and/or that a push notification server restores from a disk only a part of the data that is stored to the disk, wherein that restored part is data that is necessary for sending a real-time push notification to a client.

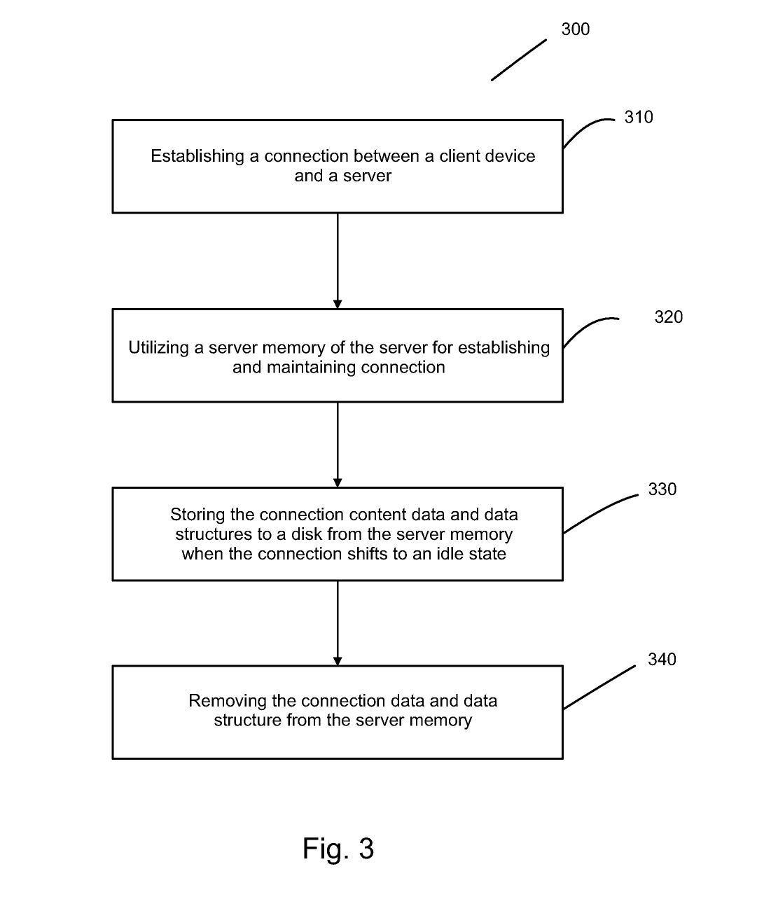

FIG. 3 shows a flow chart of a server memory optimizing method 300 for a real-time system according to an example embodiment. In step 310 a connection is established between a client device and a server, wherein the server is suitable to have a plurality of concurrent connections with plurality of client devices. In step 320 a server memory of the server is utilized for establishing and maintaining connection of the client device with the server. Connection content data and data structures are stored to the server memory. In step 330 the connection shifts to an idle state and the connection content data and data structures are stored to a disk from the server memory. In step 340 the connection data and data structure are removed from the server memory. The server may be, for example, a real-time push notification server, video or audio streaming server or any other suitable server that uses persistent connections.

The various embodiments of the invention can be implemented with the help of computer program code that resides in a memory and causes the relevant apparatuses to carry out the invention. For example, a device may comprise circuitry and electronics for handling, receiving and transmitting data, computer program code in a memory, and a processor that, when running the computer program code, causes the device to carry out the features of an embodiment. Yet further, a network device like a server may comprise circuitry and electronics for handling, receiving and transmitting data, computer program code in a memory, and a processor that, when running the computer program code, causes the network device to carry out the features of an embodiment.

It is obvious that the present invention is not limited solely to the above-presented embodiments, but it can be modified within the scope of the appended claims.

1-27. (canceled)

28. A method, comprising:
establishing a connection between a client device and a server suitable to have a plurality of connections with a plurality of client devices;
utilizing a server memory of the server for establishing and maintaining connection of the client device with the server by connection content data and data structures;
storing the connection content data and data structures to a disk from the server memory when the connection shifts to an idle state; and
removing the connection data and data structure from the server memory.

29. A method according to claim 28, wherein the server is a real-time push notification server.

30. A method according to claim 29, wherein the method further comprises restoring the connection data and data structure to the server memory when server is indicated about a real-time push notification to be delivered to the client device.

31. A method according to claim 28, wherein the server is a video or audio streaming server.

32. A method according to claim 28, wherein the connection content data and data structures are stored to the disk after the connection has been in the idle state for a predetermined time.

33. A method according to claim 28 wherein the connection content data and data structures are stored to the disk in the idle state if the server has more than a predetermined number of concurrent connections with client devices.

34. A method according to claim 28, wherein the connection content data and data structures are stored to the disk in every second or third idle state.

35. A method according to claim 28, wherein the connection content data and data structures are stored to the disk for idle state if the server memory capacity is running low.

36. An apparatus comprising at least one processor, memory including computer program code, the memory and the computer program code configured to, with the at least one processor, cause the apparatus to perform at least the following:
establish a connection between a client device and a server suitable to have a plurality of connections with a plurality of client devices;
utilize a server memory of the server for establishing and maintaining connection of the client device with the server by connection content data and data structures;
store the connection content data and data structures to a disk from the server memory when the connection shifts to an idle state; and
remove the connection data and data structure from the server memory.

37. An apparatus according to claim 36, wherein the server is a real-time push notification server.

38. An apparatus according to claim 37, wherein computer program code is configured to, when executed on at least one processor, further cause the apparatus to:
restore the connection data and data structure to the server memory when server is indicated about a real-time push notification to be delivered to the client device.

39. An apparatus according to claim 36, wherein the server is a video or audio streaming server.

40. An apparatus according to claim 36, wherein the connection content data and data structures are stored to the disk after the connection has been in the idle state for a predetermined time.

41. An apparatus according to claim 36, wherein the connection content data and data structures are stored to the disk in the idle state if the server has more than a predetermined number of concurrent connections with client devices.

42. An apparatus according to claim 36, wherein the connection content data and data structures are stored to the disk in every second or third idle state.

43. An apparatus according to claim 36, wherein the connection content data and data structures are stored to the disk for idle state if the server memory capacity is running low.

44. A computer program product embodied on a non-transitory computer readable medium, comprising computer program code configured to, when executed on at least one processor, cause an apparatus to:
establish a connection between a client device and a server suitable to have a plurality of connections with a plurality of client devices;
utilize a server memory of the server for establishing and maintaining connection of the client device with the server by connection content data and data structures;
store the connection content data and data structures to a disk from the server memory when the connection shifts to n idle state; and
remove the connection data and data structure from the server memory.

45. A computer program product according to claim 44, wherein the server is a real-time push notification server.

46. A computer program product according to claim 45, wherein computer program code configured to, when executed on at least one processor, further cause the apparatus to:
restore the connection data and data structure to the server memory when server is indicated about a real-time push notification to be delivered to the client device.
